(19) United States
(12) Patent Application Publication
(10) Pub. No.: US 2007/0014328 A1
(43) Pub. Date: Jan. 18, 2007

(54) Infrared clinical thermometer circuit device and memory selection device thereof

(76) Inventors: Vincent Weng, HsinChu (TW); Jason Liao, HsinChu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/527,507

(22) Filed: Sep. 27, 2006

(30) Foreign Application Priority Data
Feb. 12, 2005 (TW) 94142551

(51) Int. Cl. G01J 5/00

(52) U.S. Cl. 374/121

(57) ABSTRACT

An infrared clinical thermometer circuit device and a memory selection device thereof are proposed, in which the basal body temperature setting function is added to an infrared clinical thermometer so that the clinical thermometer can set an exclusive basal body temperature value for each user as the reference for determining whether he gets a temperature, thereby making the determination more accurate. Moreover, the memory selection device is used to expand the application of the infrared clinical thermometer. The infrared clinical thermometer can be used for several users and thus apply to multi-member families, hence enhancing the convenience of use of the infrared clinical thermometer.

### BACKGROUND OF THE INVENTION

1. Field of the Invention

The present invention relates to an electronic clinical thermometer and, more particularly, to an infrared clinical thermometer capable of allowing the user to set exclusive basal body temperatures. Moreover, by using a memory selection device, the infrared clinical thermometer can be expanded to apply to multi-member families.

2. Description of Related Art

The body temperature is a health index of the human body. The health status of the immune system of the human body is usually shown with the variation of the body temperature. Therefore, the clinical thermometer is an essential tool of almost every family. With the continual progress of science and technology, tools for measuring the body temperature have developed from conventional mercury clinical thermometers to various different electronic clinical thermometers. Among these electronic clinical thermometers, infrared clinical thermometers (e.g., forehead clinical thermometers, ear clinical thermometers, and so on) are the most exact and convenient. Because the infrared clinical thermometers have the advantages of high accuracy, easy operation, and quick measurement, they have gradually become one of the mainstream methods for measuring the body temperature.

Most existent infrared clinical thermometers have a fever alarming function. When the subject is found to be under an attack of fever, an alarming sound is given out or the display flashes to inform the user. The temperature above which an alarm will be given out is usually a fixed temperature value (e.g., 37.5° C.). The reason why the alarming temperature is set to 37.5° C. is that the average basal body temperature of normal people is 37.0° C. according to statistics. However, not every person has a basal body temperature of 37.0° C. The body temperatures of some people will be higher or lower than this standard. Therefore, the fever-alarming temperature of every person should be different. For instance, the fever-alarming temperature of infants smaller than three months is 38° C., the fever-alarming temperature of children is 38.7° C., and the fever-alarming temperature of adults is 37.8° C. But the above standards also come from statistics. In conclusion, there are doubts in using an absolute temperature value as an alarming standard for the determination of fever.

### SUMMARY OF THE INVENTION

An object of the present invention is to provide an infrared clinical thermometer circuit device and a memory selection device thereof, in which the basal body temperature of a subject can be set and recorded, and the set basal body temperature value is referred to during measurement for the determination of whether to give out an fever alarm or not, thereby effectively improving the conventional alarming function and making the determination of fever more accurate.

Another object of the present invention is to provide an infrared clinical thermometer circuit device and a memory selection device thereof, in which the memory selection device is used to select among different users, and the setting of basal body temperature can be expanded to multiple members of the family, thereby enhancing the convenience in use and the added value of the infrared clinical thermometer.

According to the present invention, an infrared clinical thermometer circuit device comprises a measuring key unit, a sensor, a display unit and a setting key unit. The measuring key unit is operated by the user to send out an activation signal to a microprocessor that is connected to a memory device and the display unit. The sensor is controlled by the microprocessor. After the microprocessor receives the activation signal, the sensor immediately performs temperature measurement and then sends a temperature signal back to the microprocessor. The display unit then displays the temperature signal. The setting key unit is on the clinical thermometer and operated by the user to set a numeric value displayed by the display unit as an exclusive basal body temperature. Moreover, the basal body temperature is stored in the memory device and displayed on the display unit.

The present invention also provides a memory selection device of an infrared clinical thermometer. The memory selection device comprises a switching device, a display unit and a memory unit. The switching device is used to switch between a plurality of different users. The display unit is used to display measurement data of different users. The memory unit has a plurality of memory blocks. Each of the memory blocks can store the measurement data of a user.

### BRIEF DESCRIPTION OF THE DRAWINGS

The various objects and advantages of the present invention will be more readily understood from the following detailed description when read in conjunction with the appended drawing, in which:

FIG. 1 is a system block diagram of the present invention;

FIG. 2 is a partial view of the appearance of the present invention;

FIG. 3 is a flowchart of setting a basal body temperature of the present invention;

FIG. 4 is a diagram of the present invention with the basal body temperature displayed on the display unit; and

FIG. 5 is a flowchart of measuring and recording the body temperatures of several members of the present invention.

### DETAILED DESCRIPTION OF THE PREFERRED EMBODIMENTS

The present invention provides a clinical thermometer circuit device that lets a user be able to set an exclusive personal basal body temperature, making the determination and alarming of fever more accurate. Moreover, the clinical thermometer can switch between and discriminate different users and separately record the measurement data to facilitate the operation.

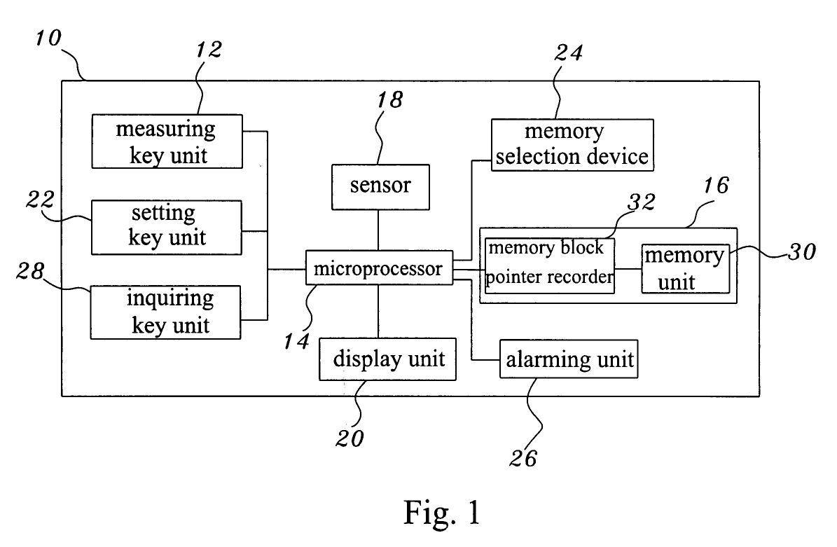

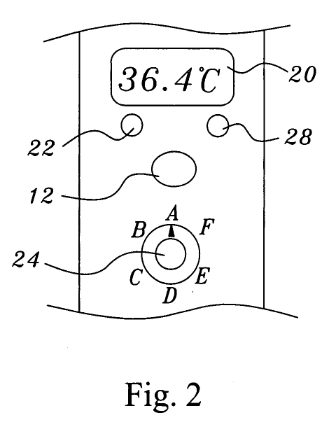

As shown in FIGS. 1 and 2, a clinical thermometer circuit device 10 comprises a measuring key unit 12, which is operated by the user to send out an activation signal to a microprocessor 14. The microprocessor 14 is connected to a memory device 16, a sensor 18, a display unit 20, a setting key unit 22, a memory selection device 24, an alarming unit 26 and an inquiring key unit 28. After the microprocessor 14 receives the activation signal, the sensor 18 is controlled to perform temperature measurement. After measurement, the sensor 18 sends a temperature signal back to the microprocessor 14. The temperature signal is also displayed on the display unit 20. The display unit 20 is an LCD.

The setting key unit 22 can set a temperature numeric displayed on the display unit 20 as an exclusive basal body temperature, which is stored in the memory device 16 and displayed on the display unit 20. The memory device 16 includes a memory unit 30 and a memory block pointer recorder 32 that are connected together. The memory unit 30 is a RAM or an EEPROM. The memory unit 30 has a plurality of memory blocks of an array or queue structure. The memory block pointer recorder 32 is used to record the block location of each piece of measurement data stored in the memory unit 30. The inquiring key unit 28 is used by the user to inquire about the stored data, and the stored data can be a measured temperature value, a basal body temperature, or their combination.

The memory selection device 24 can be operated by different users to switch to the corresponding basal body temperatures (A, B, . . . F shown in FIG. 2) for measurement. In this embodiment, the memory selection device 24 is a rotary switch. The memory selection device 24 can also be in the form of selection keys. After the measurement of the body temperature is finished, the microprocessor 14 compares a difference value between the set basal body temperature value and the measured temperature value. The alarming unit 26 gives out an alarm or not based on this difference value. This difference value comes from the medical statistics. According to the present statistics standard, an alarm is given out as long as the measured temperature value is larger than the set basal body temperature value by at least 0.5° C. However, this difference value differs between adults, children and old persons. The alarming unit 26 gives out an alarm with sound or through flashing of the display unit 20.

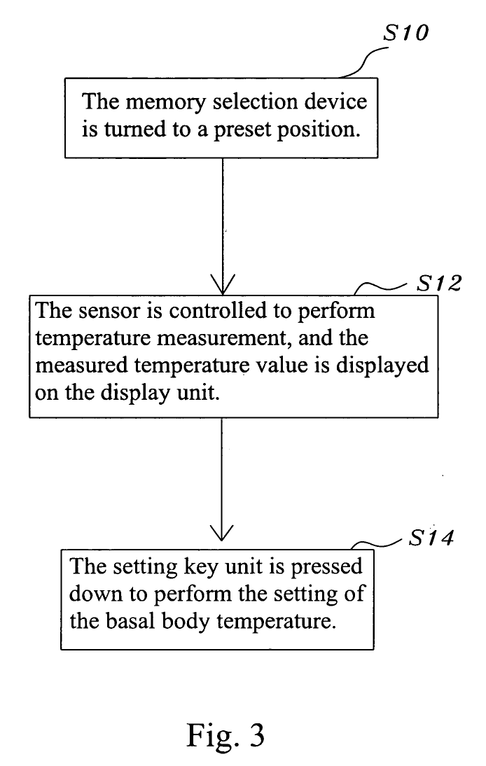

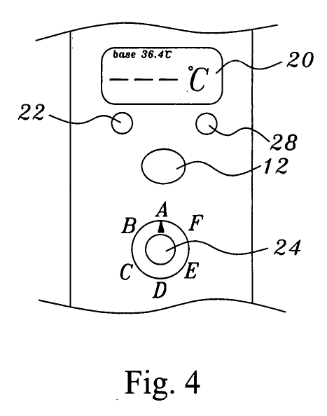

FIG. 3 is a flowchart of setting a basal body temperature of the present invention. Before measurement, the body temperature of the subject should be under normal condition. First, to perform a step S10, the memory selection device 24 is turned to a preset position (e.g., point A in FIG. 1 representing the subject A), and the sensing end (probe head) of the clinical thermometer 10 is placed in the ear of the subject. Next, to perform a step S12, the measuring key unit 12 is pressed down to drive the sensor 18 to perform temperature measure, and a temperature value is then sent back and also displayed on the display unit 20. Finally, to perform a step S14, the setting key unit 22 is pressed down to set the temperature value displayed on the display unit 20 as the basal body temperature of the subject A, and this basal body temperature is simultaneously stored in a block of the memory unit 30 via the memory block pointer recorder 32 and displayed on the display unit 20, as shown in FIG. 4. This finishes the setting of the basal body temperature.

In the above setting procedure, if the memory selection device 24 is used to be switched to a different user, a different basal body temperature can be set. In this way, exclusive basal body temperatures of different users can be recorded.

Afterwards, when a user wants to operate the clinical thermometer of the present invention, he only needs to switch to his exclusive position through the memory selection device 24, and the display unit 20 will automatically display the corresponding basal body temperature. During measurement, the microprocessor 14 will refer to this basal body temperature as the basis for the determination of fever.

Besides, the memory selection device 24 can also be used to reinforce the memory function of conventional clinical thermometers. Although the measurement and memory function of conventional clinical thermometers can provide the previously measured records, it is unable to discriminate which measurement record belongs to which subject when there are more than one user, especially in a multi-member family. When the measurement and memory function of the clinical thermometer of the present invention is used, the memory selection device 24 can be operated to switch between different users and provide exclusive measured record data.

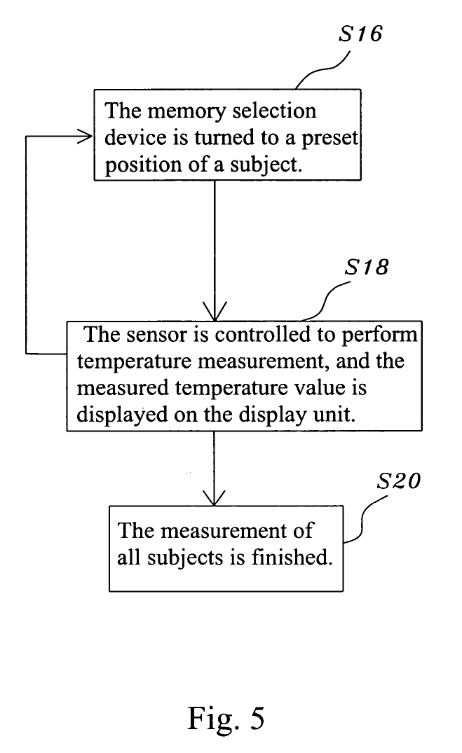

FIG. 5 is a flowchart of measuring and recording several members of the present invention. First, to perform a step S16, the memory selection device 24 is switched to the position of a corresponding subject. Next, to perform a step S18, the sensing end of the clinical thermometer is placed in the ear of the subject, and the measuring key unit 12 is pressed down to drive the sensor 18 to perform temperature measurement, and a temperature value is then sent back and also displayed on the display unit 20, and this temperature value is stored in a block of the memory unit 30 via the memory block pointer recorder 32. Steps S16 and S18 are repeated until the measurement of all subjects is finished, hence ending this procedure (Step S20). Several users can be measured and their measurement results can be recorded in this way. Afterwards, by switching to a certain user using the memory selection device 24, the inquiring key unit 28 can be used to inquire about the exclusive record data of this user. Besides, when performing Step S18, if the temperature value sent-back is larger than the set basal body temperature value of this user by at least 0.7° C., the alarming unit 26 will give out an alarm to inform the subject or the operator that an abnormal situation of the body temperature occurs.

To sum up, the infrared clinical thermometer of the present invention can set an exclusive basal body temperature for each user to make the determination and alarming of fever more accurate. Moreover, the memory selection device can be used to select among different users, and the setting of basal body temperature can be expanded to multiple users, and the conventional memory function of clinical thermometer can be reinforced to apply to multiple users, thereby enhancing the convenience in use and the added value of the infrared clinical thermometer.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An infrared clinical thermometer circuit device comprising:
a measuring key unit operated by a user to send out an activation signal to a microprocessor that is connected to a memory device;
a sensor controlled by said microprocessor, said sensor immediately performing temperature measurement and then sending a temperature signal back to said microprocessor after said microprocessor receives said activation signal;
a display unit connected to said microprocessor and used to display said temperature signal; and
a setting key unit operated by the user to set a numeric value displayed by said display unit as an exclusive basal body temperature, said basal body temperature being stored in said memory device and displayed on said display unit.

2. The infrared clinical thermometer circuit device as claimed in claim 1 further comprising an alarming unit, wherein after the measurement is finished, said basal body temperature and a measured temperature value are compared, and whether said alarming unit gives out an alarm is based on the comparison result.

3. The infrared clinical thermometer circuit device as claimed in claim 2, wherein said alarming unit gives out a sound-type alarm.

4. The infrared clinical thermometer circuit device as claimed in claim 2, wherein said alarming unit gives out an alarm through flashing of said display unit.

5. The infrared clinical thermometer circuit device as claimed in claim 1, wherein said microprocessor is further connected to a recording key unit that is used to record the sensed temperature.

6. The infrared clinical thermometer circuit device as claimed in claim 1, wherein said display unit is an LCD.

7. The infrared clinical thermometer circuit device as claimed in claim 1, wherein said memory unit is a RAM or an EEPROM.

8. A memory selection device of an infrared clinical thermometer used to select among a plurality of users, said memory selection device comprising:
a switching device used to switch between a plurality of different users;
a display unit used to display measurement data of different users; and
a memory unit having a plurality of memory blocks, each said memory block being able to store said measurement data of a user.

9. The memory selection device of an infrared clinical thermometer as claimed in claim 8, wherein said switching device can be a rotary switch, a sliding switch, or selection keys.

10. The memory selection device of an infrared clinical thermometer as claimed in claim 8, wherein said memory unit is a RAM or an EEPROM.

11. The memory selection device of an infrared clinical thermometer as claimed in claim 8, wherein said memory block is of an array data structure or a queue data structure.

12. The memory selection device of an infrared clinical thermometer as claimed in claim 8, wherein said measurement data can be a measured temperature value, a basal body temperature, or their combination.

13. The memory selection device of an infrared clinical thermometer as claimed in claim 8, wherein said display unit can be used to display a measurement record or a basal body temperature of a user when switching between different users.

14. The memory selection device of an infrared clinical thermometer as claimed in claim 8 further comprising a memory block pointer recorder, wherein said memory block pointer recorder is connected to said memory unit and used to label the location of said memory block of each said measurement data.
